(19) United States
(12) Patent Application Publication
(10) Pub. No.: US 2022/0097426 A1
(43) Pub. Date: Mar. 31, 2022

(54) METHOD FOR MANUFACTURING ELASTIC BODY HAVING TWO-LAYER STRUCTURE, CYLINDER MEMBER, AND IMAGE FORMING APPARATUS

(71) Applicant: FUJIFILM Business Innovation Corp., Tokyo (JP)

(72) Inventors: Toshiaki BABA, Kanagawa (JP); Tomoaki YOSHIOKA, Kanagawa (JP); Yoko MIYAMOTO, Kanagawa (JP); Kazuki KISHI, Kanagawa (JP); Yosuke TSUTSUMI, Kanagawa (JP)

(73) Assignee: FUJIFILM Business Innovation Corp., Tokyo (JP)

(21) Appl. No.: 17/330,597

(22) Filed: May 26, 2021

(30) Foreign Application Priority Data
Sep. 30, 2020 (JP) 2020-166252

(51) Int. Cl. B41J 15/04; G03G 15/00; B65H 5/06

(52) U.S. Cl. CPC B41J 15/046; B65H 5/062; G03G 15/6529; G03G 15/652

(57) ABSTRACT

A method for manufacturing an elastic body having a two-layer structure includes: forming a first elastic body on a provisional cylinder body having a substantially circular shape in cross section; and forming a second elastic body integrally with the first elastic body, which has been formed on the provisional cylinder body.

### CROSS-REFERENCE TO RELATED APPLICATIONS

This application is based on and claims priority under 35 USC 119 from Japanese Patent Application No. 2020-166252 filed Sep. 30, 2020.

### BACKGROUND

### (i) Technical Field

The present disclosure relates to a method for manufacturing an elastic body having a two-layer structure, a cylinder member, and an image forming apparatus.

### (ii) Related Art

The following transfer device has been known. That is, the transfer device includes a transport unit and a gripper piece. The transport unit moves a transfer material along a circulation movement path. The gripper piece is attached to the transport unit. The gripper piece is supported by a rotation shaft so as to rotate with respect to a base member and to grip a leading side of the transfer material. The transfer device transfers an image on an image carrier onto the transfer material (for example, see JP-A-58-005769).

### SUMMARY

Aspects of non-limiting embodiments of the present disclosure relate to prevent two layers of an elastic body from being peeled from each other when the elastic body having a two-layer structure is wound on a cylinder body, as compared with a case in which an elastic body that is manufactured by joining two layers on a flat plane is wound on the cylinder body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a method for manufacturing an elastic body having a two-layer structure, the method including: forming a first elastic body on a provisional cylinder body having a substantially circular shape in cross section; and forming a second elastic body integrally with the first elastic body, which has been formed on the provisional cylinder body.

### BRIEF DESCRIPTION OF THE DRAWINGS

Exemplary embodiment(s) of the present disclosure will be described in detail based on the following figures, wherein:

FIG. 1 is a schematic view illustrating a configuration of an image forming apparatus according to an exemplary embodiment;

FIG. 2 is a perspective view illustrating a configuration of a transfer body according to the exemplary embodiment;

FIG. 3 is a perspective view illustrating a configuration of a fixing device according to the exemplary embodiment;

FIG. 4 is a perspective view illustrating grippers according to the exemplary embodiment;

FIG. 5 is a cross-sectional view illustrating a configuration of a transfer cylinder according to the exemplary embodiment;

FIG. 6 is a cross-sectional view illustrating a first forming step of winding a first elastic body on a provisional cylinder body, according to the exemplary embodiment;

FIG. 7 is a cross-sectional view illustrating a second forming step of winding a second elastic body on the first elastic body so as to join the first elastic body and the second elastic body, according to the exemplary embodiment;

FIG. 8 is a cross-sectional view illustrating a removal step of removing the provisional body from the first elastic body and the second elastic body which are wound on the provisional cylinder body, according to the exemplary embodiment;

FIG. 9 illustrates a method for manufacturing a transfer member according to a comparative example; and

FIG. 10 is a schematic view illustrating a configuration of another image forming apparatus according to the exemplary embodiment.

### DETAILED DESCRIPTION

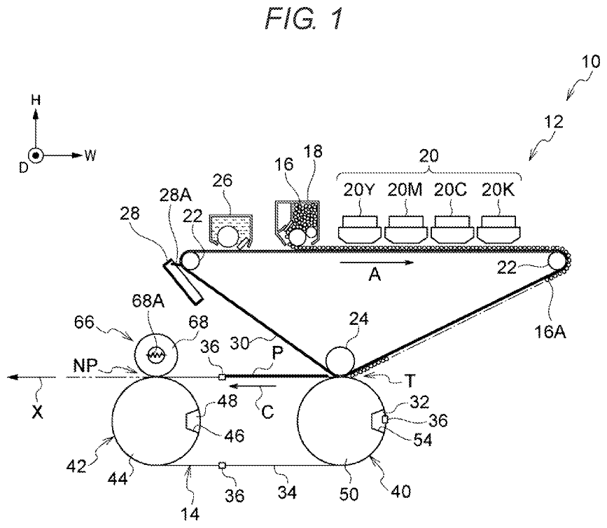

Hereinafter, an exemplary embodiment of the present disclosure will be described in detail with reference to the accompanying drawings. For the convenience of description, a direction along an arrow H illustrated in FIG. 1 will be referred to as an up and down direction of an image forming apparatus 10, a direction along an arrow W will be referred to as a width direction of the image forming apparatus 10, and a direction along an arrow D will be referred to as a front to rear direction (or a depth direction) of the image forming apparatus 10.

As illustrated in FIG. 1, the image forming apparatus 10 is, for example, an inkjet apparatus that forms an ink image (an example of an image) on a recording medium P. The image forming apparatus 10 includes an image forming unit 12, a transport unit 14, and a fixing device 66 in an apparatus body (not illustrated).

Hereinafter, the respective units of the image forming apparatus 10 (that is, the image forming unit 12, the transport unit 14, and the fixing device 66) will be described, followed by a description on (i) a transfer member 60 constituting a transfer cylinder 50 (an example of a cylinder member) and (ii) a method for manufacturing the transfer member 60 will be described.

### Image Forming Unit

The image forming unit 12 has a function of forming the ink image on the recording medium P. Specifically, the image forming unit 12 includes a transfer belt 30 (an example of an intermediate transfer body), plural rollers 22 (in this exemplary embodiment, two rollers 22), an opposing roller 24, an adhesive layer forming device 26, a particle supply device 18, an ejection head 20, a transfer body 40, and a cleaner 28.

The transfer belt 30 is formed in an endless shape. The transfer belt 30 is wound on the two rollers 22 and the opposing roller 24 so as to have a posture of an inverted triangle shape when viewed from the apparatus depth direction. At least one roller of the two rollers 22 is driven to rotate, so that the transfer belt 30 rotates and moves in a direction indicated by an arrow A.

The adhesive layer forming device 26, the particle supply device 18, the ejection head 20, the transfer body 40, and the cleaner 28 are arranged on an outer circumferential surface side of the transfer belt 30 in this order from an upstream side in a direction in which the transfer belt 30 rotates (hereinafter referred to as a “belt rotation direction”).

The adhesive layer forming device 26 is disposed at an end portion on one side (specifically, an end portion on a left side in FIG. 1), in the device width direction, of a horizontal portion of the transfer belt 30 having the posture of the inverted triangle shape. The adhesive layer forming device 26 accommodates an adhesive agent therein. The adhesive layer forming device 26 applies the adhesive agent to the outer circumferential surface of the transfer belt 30, which is rotating and moving, so as to form an adhesive layer (not illustrated). Examples of the adhesive agent include glue and an organic solvent.

The particle supply device 18 is disposed in the horizontal portion of the transfer belt 30 and downstream (specifically, on a right side in FIG. 1), in the belt rotation direction, of the adhesive layer forming device 26. The particle supply device 18 accommodates ink receptive particles 16 that readily accept ink droplets. The particle supply device 18 supplies the ink acceptable particles 16 onto the transfer belt 30 on which the adhesive layer has been formed.

That is, the ink receptive particles 16 supplied by the particle supply device 18 onto the transfer belt 30 are caused to adhere to the adhesive layer by an adhering force of the adhesive layer, so as to form an ink receptive particle layer 16A on the transfer belt 30.

The ejection head 20 is disposed in the horizontal portion of the transfer belt 30 and downstream (specifically, on the right side in FIG. 1), in the belt rotation direction, of the particle supply device 18. The plural ejection heads 20 are provided so as to form ink images of respective colors. In the exemplary embodiment, the ejection heads 20 of four colors, that is, yellow (Y), magenta (M), cyan (C), and black (K) are provided. In FIG. 1, suffixes “Y”, “M”, “C”, and “K” are added after the reference numeral “20”, so as to correspond to such colors.

The ejection head 20 of each color ejects ink droplets from nozzles (not illustrated) to the ink receptive particle layer 16A using a known technique such as a thermal method or a piezoelectric method, so as to form the ink image based on image data. That is, the ink droplets ejected from the ejection head 20 of each color are accepted by the ink receptive particle layer 16A, so as to form the ink image.

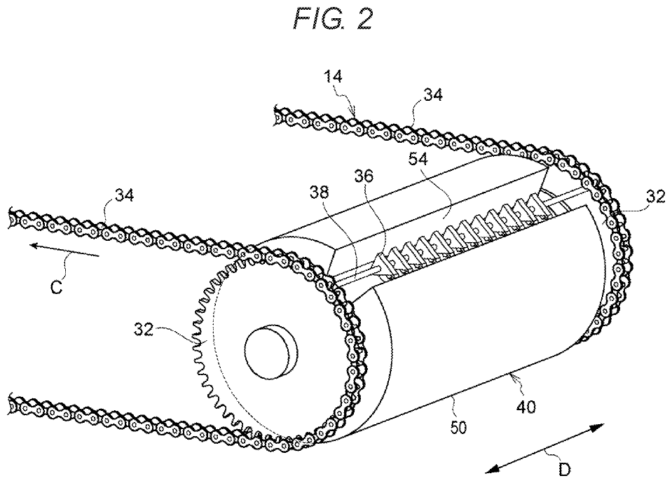

The transfer body 40 is disposed below the transfer belt 30. As illustrated in FIG. 2, the transfer body 40 includes the transfer cylinder 50 that is disposed such that an axial direction of the transfer cylinder 50 is the same as an axial direction of the opposing roller 24. The transfer cylinder 50 is disposed opposite to the transfer belt 30. The transfer cylinder 50 forms a nip region T in which the transfer cylinder 50 and the opposing roller 24 nip the transfer belt 30 (see FIG. 1).

In the exemplary embodiment, as the transfer belt 30 rotates and moves, the ink image formed in the ink receptive particle layer 16A is transported to the nip region T, and the recording medium P is transported to the nip region T by the transport unit 14. Then, the transfer cylinder 50 nips the recording medium P and the ink image, which are transported to the nip region T, with the transfer belt 30 and presses the recording medium P and the ink image so as to transfer the ink image onto the recording medium P.

In FIG. 1, a transport direction of the recording medium P is indicated by an arrow X. When the transfer cylinder 50 nips the recording medium P and the ink image in the nip region T with the transfer belt 30 and presses the recording medium P and the ink image, the transfer cylinder 50 may heat the recording medium P and the ink image. A recess 54 is formed in a part of an outer circumferential surface of the transfer cylinder 50 (specifically, a transfer cylinder body 52 which will be described later). Grippers 36 and a support member 38 (both of which will be described later) are accommodated in the recess 54.

As illustrated in FIG. 2, a pair of sprockets 32 is provided on both end portions, in the axial direction, of the transfer cylinder 50. The pair of sprockets 32 is coaxial with the transfer cylinder 50 and rotates integrally with the transfer cylinder 50. Then, the transfer body 40 (specifically, the transfer cylinder 50) is driven to rotate by a drive unit (not illustrated). A chain 34 (which will be described later) is wound on each sprocket 32.

As illustrated in FIG. 1, the cleaner 28 is disposed downstream, in the belt rotation direction, of the nip region T and upstream, in the belt rotation direction, of the adhesive layer forming device 26. The cleaner 28 includes a blade 28A that is in contact with the outer circumferential surface of the transfer belt 30. As the transfer belt 30 rotates and moves, the cleaner 28 removes residues that have passed the nip region T and still remain on the transfer belt 30, with the blade 28A. The residues include the adhesive layer, the ink receptive particles 16, the ink, and/or other foreign matter (for example, paper dust when the recording medium P is paper).

### Fixing Device

As illustrated in FIG. 1, the fixing device 66 is a device that fixes the ink image, which has been transferred onto the recording medium P, to the recording medium P. Specifically, the fixing device 66 includes a pressurizing body 42 and a heating roller 68. The pressurizing body 42 is disposed downstream in the transport direction of the recording medium P, in the transport unit 14.

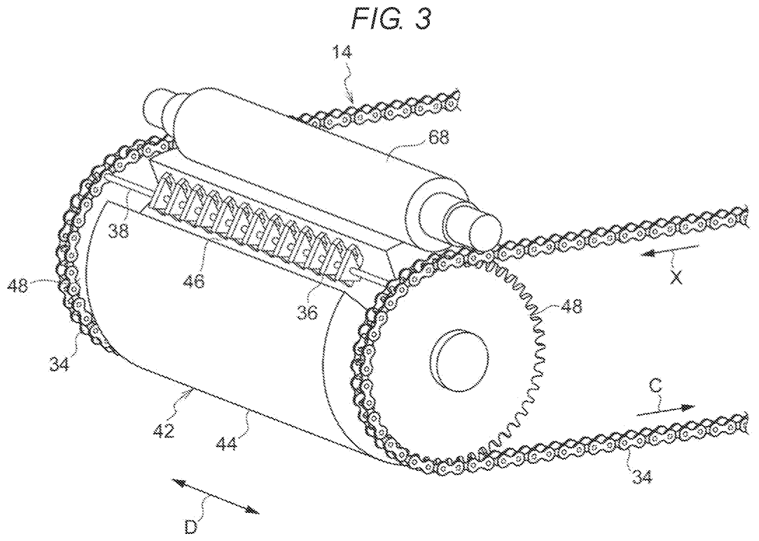

As illustrated in FIG. 3, the pressurizing body 42 includes a pressure roller 44 disposed such that an axial direction of the pressure roller 44 is the same as the axial direction of the transfer cylinder 50. A pair of sprockets 48 is disposed on both end portions, in the axial direction, of the pressure roller 44. The pair of sprockets 48 is coaxial with the pressure roller 44 and rotates integrally with the pressure roller 44. The chain 34 (which will be described later) is wound on each sprocket 48.

As illustrated in FIG. 1, the heating roller 68 and the pressure roller 44 are arranged in the up-and-down direction. That is, the heating roller 68 is disposed above the pressure roller 44. The heating roller 68 includes a heat source 68A such as a halogen lamp therein (see FIG. 1). Hereinafter, a position where the heating roller 68 and the pressure roller 44 nip the recording medium P will be referred to as a “nip position NP”.

A moving mechanism including a cam enables the heating roller 68 to move between (i) a contact position where the heating roller 68 is in contact with the pressure roller 44 and (ii) a separation position where the heating roller 68 is separated from the pressure roller 44. Specifically, the heating roller 68 is always pressed or pulled toward the contact position by an elastic force of, for example, an elastic member (such as a spring). The moving mechanism moves the heating roller 68 to the separation position against such an elastic force. At the contact position, the heating roller 68 nips the recording medium P with the pressure roller 44.

In the exemplary embodiment, the heating roller 68 is driven to rotate, and the pressure roller 44 is rotated along with the rotation of the heating roller 68. Alternatively, both the heating roller 68 and the pressure roller 44 may be driven to rotate. A recess 46 is formed in a part of an outer circumferential surface of the pressure roller 44. The grippers 36 and the support member 38 (both of which will be described later) are accommodated in the recess 44.

### Transport Unit

As illustrated in FIGS. 1 to 3, the transport unit 14 has a function of transporting the recording medium P to pass through the nip region T and the nip position NP. The transport unit 14 includes the pair of chains 34 and the grippers 36. The pair of chains 34 is an example of a driving force transmission member. The grippers 36 are an example of a holding member that holds a leading end portion of the recording medium P. FIG. 1 illustrates the chains 34 and the grippers 36 in a simplified manner.

As illustrated in FIG. 1, each chain 34 is formed in an annular shape. As illustrated in FIGS. 2 and 3, the chains 34 are arranged at an interval in the apparatus depth direction. That is, the chains 34 are respectively wound on (i) the sprockets 32, which are coaxial with the transfer cylinder 50, and (ii) the sprockets 48, which are coaxial with the pressure roller 44.

Therefore, when the transfer cylinder 50 (the transfer body 40) is driven to rotate by the drive unit, the pressure roller 44 (pressurizing body 42) is rotated along with the rotation of the transfer cylinder 50 (the transfer body 40) through the pair of sprockets 32, the pair of chains 34, and the pair of sprockets 48. That is, a rotational driving force of the transfer cylinder 50 is transmitted to the pressure roller 44 by the pair of chains 34 which rotates and moves in a rotation direction C (see FIG. 1).

As illustrated in FIGS. 2 and 3, the support member 38 to which the grippers 36 are attached bridges between the chains 34 along the apparatus depth direction. The plural support members 38 (three support members 38 in FIG. 1) are provided. The support members 38 are arranged at predetermined intervals along a circumferential direction (that is, the rotation direction C) of the chains 34. Each support member 38 is fixed to the pair of chains 34.

Also, the plural grippers 36 are arranged at a predetermined interval along the apparatus depth direction and mounted on each supporting member 38. That is, the grippers 36 are attached to the chains 34 through each supporting member 38. Then, each gripper 36 has a holding function of holding the leading end portion of the recording medium P.

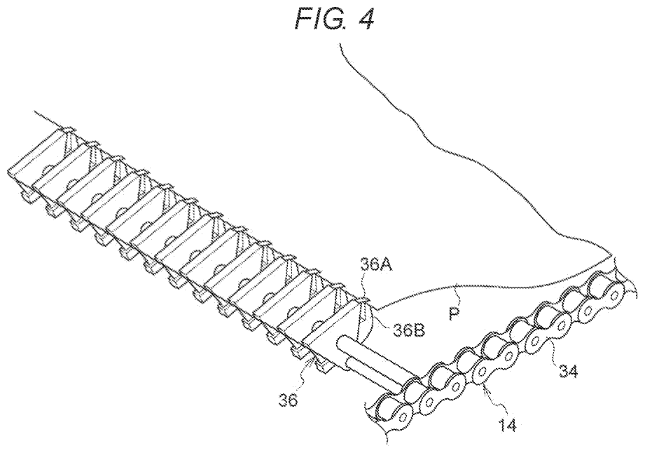

Specifically, as illustrated in FIG. 4, each gripper 36 includes a claw 36A and a claw base 36B. The grippers 36 hold the recording medium P by sandwiching the leading end portion of the recording medium P between the claws 36A and the claw bases 36B. Therefore, the grippers 36 are an example of a sandwiching unit that sandwiches the recording medium P in a thickness direction thereof.

Also, the grippers 36 which are located downstream, in the transport direction, of the recording medium P hold the leading end portion of the recording medium P from a downstream side in the transport direction of the recording medium P. Each grippers 36 is configured such that, for example, the claw 36A is pressed against the claw base 36B by a spring or the like, and the claw 36A is separated from the claw base 36B by an action of a cam or the like.

In this manner, in the transport unit 14, the grippers 36 hold the leading end portion of the recording medium P fed from an accommodating unit (not illustrated) that accommodates recording media P. Then, in the transport unit 14, the chains 34 rotate and move in the rotation direction C in a state where the grippers 36 hold the leading end portion of the recording medium P, so that the grippers 36 are moved to transport the recording medium P, and the recording medium P passes through the nip region T together with the grippers 36 while the grippers 36 are holding the recording medium P.

In a portion where the chains 34 are wound on the sprockets 32, the grippers 36 move in a rotation direction of the transfer cylinder 50 together with the transfer cylinder 50 in a state of being accommodated in the recess 54 of the transfer cylinder 50. Similarly, in a portion where the chains 34 are wound on the sprockets 48, the grippers 36 move in a rotation direction of the pressure roller 44 together with the pressure roller 44 in a state of being accommodated in the recess 46 of the pressure roller 44.

Here, in a state in which the heating roller 68 is located at the separation position, the transport unit 14 of the exemplary embodiment transports the recording medium P toward the nip position NP while the grippers 36 are holding the leading end portion of the recording medium P. In response to the transport unit 14 transporting the recording medium P to the nip position NP, the transport unit 14 releases the holding of the leading end portion of the recording medium P.

That is, after the grippers 36 has passed through the nip position NP, the transport unit 14 releases the holding of the leading end portion of the recording medium P. At this time, the pressure roller 44 maintains a rotating state (that is, a state in which the chains 34 are rotating and moving).

A detector (specifically, a sensor) is disposed upstream, in the transport direction, of the nip position NP. The detector detects an event that the recording medium P has transported to the nip position NP, based on a time that has elapsed since detecting the leading end of the recording medium P. A detection target of the detector may not be the leading end portion of the recording medium P, but may be the support member 38 or the grippers 36.

After (i) the grippers 36 have passed through the nip position NP and (ii) the holding of the leading end portion of the recording medium P by the gripper 36 is released, the heating roller 68 starts to move from the separation position to the contact position so as to nip the recording medium P transported to the nip position NP with the pressure roller 44. Then, in the state where the recording medium P is nipped between the heating roller 68 and the pressure roller 44, the heating roller 68 starts to rotate so as to transport the recording medium P.

The heating roller 68 may start to move from the separation position to the contact position before the holding of the leading end portion of the recording medium P by the gripper 36 is released, if the nipping of the recording medium P between the heating roller 68 and the pressure roller 44 is completed after the holding of the leading end portion of the recording medium P by the gripper 36 is released.

As described above, the fixing device 66 heats and presses the recording medium P while transporting the recording medium P in a state in which the heating roller 68 and the pressure roller 44 nip the recording medium, so that the fixing device 66 fixes the ink image, which has been transferred onto the recording medium P, to the recording medium P. Transfer Member and Method for Manufacturing the Transfer Member

Next, the transfer member 60 of the image forming apparatus 10 having the configuration described above and a method for manufacturing the transfer member 60 will be described. The transfer member 60 is an example of an elastic body having a two-layer structure and constitutes the transfer cylinder 50.

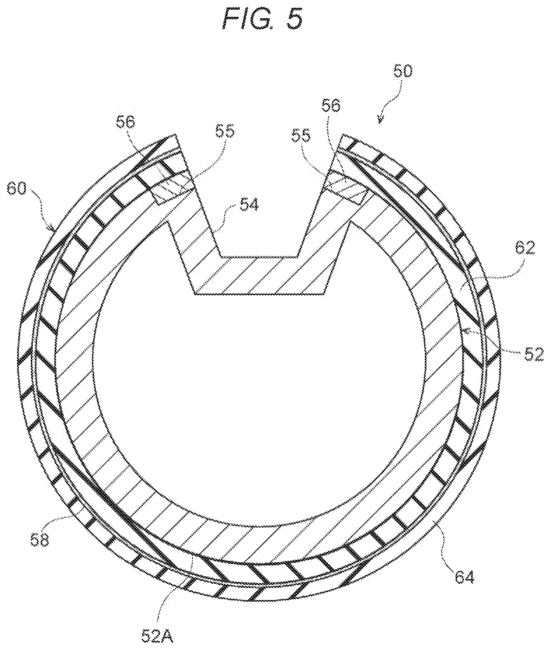

As illustrated in FIG. 5, the transfer cylinder 50 includes the transfer cylinder body 52 (an example of a cylinder body) and the transfer member 60 wound on the transfer cylinder body 52. A length of the transfer cylinder body 52 along the axial direction thereof is longer than a length (that is, a width) of the transfer member 60 along an axial direction thereof. The transfer member 60 is wound on the transfer cylinder body 52 such that a center portion of the transfer member 60 in the width direction thereof coincides with a center portion of the transfer cylinder body 52 in the axial direction thereof. The transfer member 60 has a width larger than the maximum width of the recording medium P.

The transfer cylinder body 52 is formed in a substantially tubular shape (having a substantially circular shape in cross section). The single recess 54 is formed in a part of an outer circumferential surface 52A of the transfer cylinder body 52 to extend along the axial direction thereof. The recess 54 is an example of a recess. In the recess 54, the grippers 36 and the like described above are accommodated. The transfer cylinder body 52 is made of a metal material such as stainless steel, aluminum, and/or copper.

Step portions 55 are formed in both edge portions of an opening that defines the recess 54 of the transfer cylinder body 52 when viewed from the axial direction of the transfer cylinder body 52. Each step portion 55 has a rectangle shape having (i) a length along a circumferential direction and (ii) a length along a radial direction that is shorter than the length along the circumferential direction. Then, a fixing member 56 (which will be described later) is disposed in each step portion 55.

The transfer member 60 includes a first elastic body 62 (which will be described later) having a first end portion and a second end portion in a circumferential direction. The fixing members 56 each having an elongated plate shape are respectively bonded to an inner circumferential surface of the first elastic body 62 at the first and second end portions with a joining unit (such as a double-sided tape) in advance. Each fixing member 56 extends in the axial direction of the transfer cylinder body 52. When viewed from the axial direction of the transfer cylinder body 52, each fixing member 56 has a rectangle shape (that is, the same shape as that of a respective one of the step portions 55) having (i) a length along the circumferential direction and (ii) a length along the radial direction shorter than the length along the circumferential direction.

A length of each fixing member 56 along the axial direction of the transfer cylinder body 52 is longer than the length (that is, the width) of the transfer member 60 along the axial direction thereof. Each fixing member 56 protrudes outward in the width direction from both end portions, in the width direction, of the transfer member 60. Each fixing member 56 is disposed in the respective one of the step portions 55. Both end portions of each fixing member 56 protrude from both end portions, in the width direction, of the transfer member 60 and are fixed to the respective one of the step portions 55 by screws or the like.

Next, the transfer member 60 will be described. The transfer member 60 includes the first elastic body 62 and a second elastic body 64. The first elastic body 62 is wound on the outer circumferential surface 52A (which is a surface to be wound) of the transfer cylinder body 52 without adhering to the outer circumferential surface 52A. The second elastic body 64 is joined to the outer circumferential surface 62A of the first elastic body 62 by a double-sided tape 58. The first elastic body 62 is made of a foam rubber. The second elastic body 64 is made of a solid rubber and is conductive. A thickness of the first elastic body 62 is larger than that of the second elastic body 64.

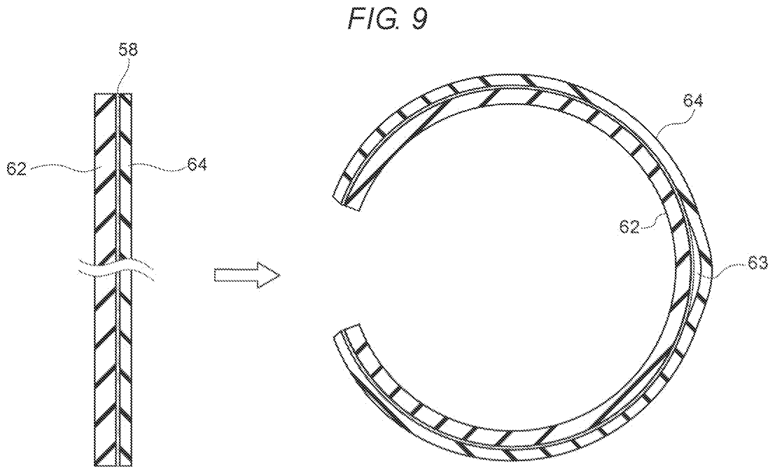

Here, consider a comparative example in which as illustrated in FIG. 9, the first elastic body 62 is joined to the second elastic body 64 by the double-sided tape 58 on a flat plane to obtain a joined structure and the joined structure is bent into a substantial “C” shape when viewed from the axial direction of the transfer cylinder body 52 in order to wind the joined structure on the outer circumferential surface 52A of the transfer cylinder body 52. In this comparative example, the first elastic body 62 on an inner circumferential side and the second elastic body 64 on an outer circumferential side become different in a length in the circumferential direction due to the thicknesses of the first and second elastic bodies 62 and 64 (that is, tension is applied in the circumferential direction), a strain portion, that is, a peeling portion 63 may be formed.

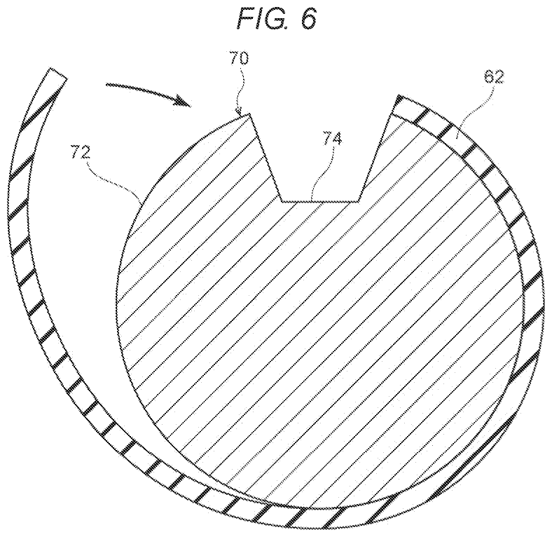

Accordingly, the transfer member 60 is manufactured by a manufacturing method illustrated in FIGS. 6 to 8. Specifically, at first, a provisional cylinder body 70 having a provisional winding surface 72 is prepared as illustrated in FIG. 6. The provisional winding surface 72 has a dimension and a shape (for example, an outer diameter ratio of 80% to 120%) that correspond to the outer circumferential surface 52A of the transfer cylinder body 52 which is a winding target. Then, the first elastic body 62 is wound on the provisional winding surface 72 of the provisional cylinder body 70 without adhering to the provisional winding surface 72 (a first forming step in the exemplary embodiment).

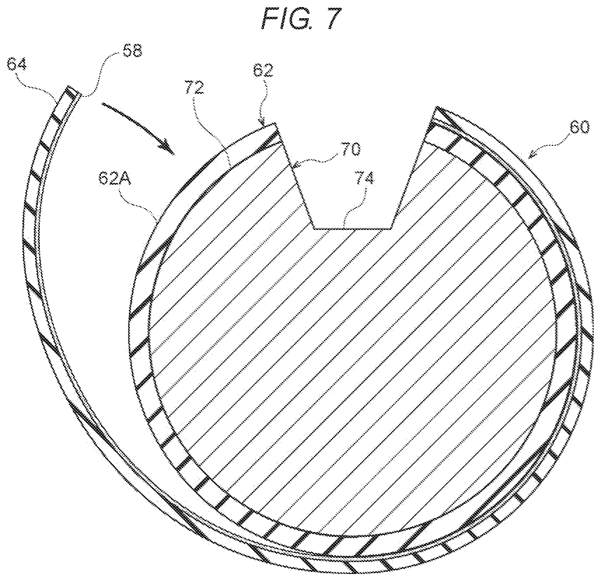

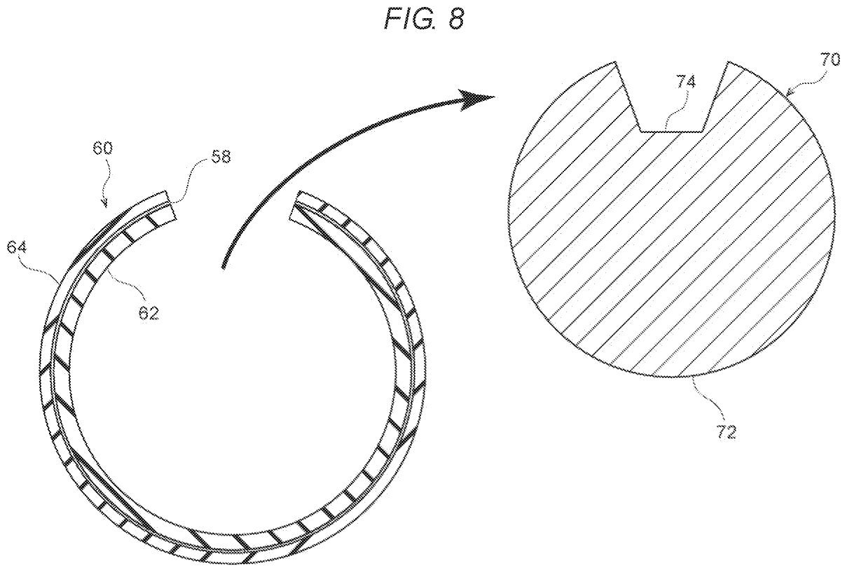

Here, the double-sided tape 58 is bonded to an inner circumferential surface of the second elastic body 64 in advance. Next, as illustrated in FIG. 7, the second elastic body 64 is wound on and joined to the outer circumferential surface 62A of the first elastic body 62, which has been wound on the provisional cylinder body 70 (a second forming step in the exemplary embodiment). Thereafter, as illustrated in FIG. 8, the provisional cylinder body 70 is removed from the first and second elastic bodies 62 and 64 which are joined together (a removal step in the exemplary embodiment).

Accordingly, in order to wind the first and second elastic bodies 62 and 64 on the outer circumferential surface 52A of the transfer cylinder body 52, the transfer member 60 which is bent into the substantial “C” shape (that is, which has a bending tendency) when viewed from the axial direction of the transfer cylinder body 52 is manufactured.

In FIGS. 6 to 8, the fixing members 56 are not illustrated. It is noted that the first and second end portions, in the circumferential direction, of the first elastic body 62 are temporarily fixed to the provisional cylinder body 70 by the fixing members 56. The provisional cylinder body 70 has a recess 74 corresponding to the recess 54. Alternatively, the provisional cylinder body 70 may have no recess 74.

Next, an operation of the transfer member 60 according to the exemplary embodiment configured as described above and the method for manufacturing the transfer member 60 will be described.

As illustrated in FIGS. 6 to 8, the transfer member 60 is manufactured by winding the first elastic body 62 on the provisional cylinder body 70 including the provisional winding surface 72 having the dimension and the shape corresponding to the outer circumferential surface 52A of the transfer cylinder body 52 without the first elastic body 62 adhering to the provisional cylinder body 70, and then winding the second elastic body 64 on the first elastic body 62 so as to join the second elastic body 64 to the first elastic body 62 by the double-sided tape 58.

Accordingly, as compared with a case in which the transfer member 60 is manufactured by joining the second elastic body 64 to the first elastic body 62 by the double-sided tape 58 on a flat plane to form a joined structure and thereafter, bending the joined structure into a substantial “C” shape in cross section (that is, bending the transfer member 60 so as to have a bending tendency), the peeling portion 63 is prevented or inhibited from being formed between the first elastic body 62 and the second elastic body 64.

As described above, the joining unit that joins the second elastic body 64 to the outer circumferential surface 62A of the first elastic body 62 after the second elastic body 64 is wound on the outer circumferential surface 62A of the first elastic body 62 is the double-sided tape 58.

The transfer member 60 (specifically, the first elastic body 62) which is replaceable with respect to the transfer cylinder body 52 may be distributed to the market in a state in which the fixing members 56 are joined to the transfer member 60 (specifically, the first elastic body 62) in advance.

### Another Image Forming Apparatus

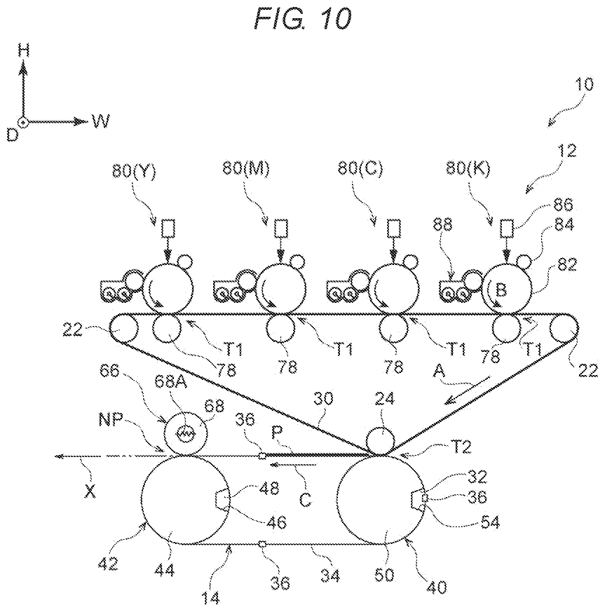

The image forming apparatus 10 according to the exemplary embodiment is not limited to the inkjet image forming apparatus described above, but may be an electrophotographic image forming apparatus as illustrated in FIG. 10, for example. That is, instead of the adhesive layer forming device 26, the particle supply device 18, and the ejection heads 20, toner image forming units 80 that form toner images (an example of an image) of respective colors may be provided.

Each of the toner image forming units 80 (80Y, 80M, 80C, 80K) of the respective colors has a columnar photoconductor 82 that rotates in one direction (in a direction indicated by an arrow B). Around each photoconductor 82, a charging unit 84, an exposure device 86, and a developing device 88 are arranged in order from an upstream side in a rotation direction of the photoconductor 82.

In the toner image forming unit 80 of each color, the charging unit 84 charges a surface of the photoconductor 82, and the exposure device 86 exposes the surface of the photoconductor 82 charged by the charging unit 84 so as to form an electrostatic latent image on the surface of the photoconductor 82. Then, the developing device 88 develops the electrostatic latent image, which has been formed on the surface of the photoconductor 82 by the exposure device 86, so as to form a toner image.

Primary transfer rollers 78 are provided on an inner circumferential surface side of the transfer belt 30. Each primary transfer roller 78 is opposite to a respective one of the photoconductors 82 across the transfer belt 30. The toner images formed by the toner image forming units 80 of the respective colors are successively primarily transferred to and superimposed on the transfer belt 30 at primary transfer positions T1 in which the primary transfer rollers 78 are provided. The superimposed toner images are secondarily transferred to a recording medium P at a secondary transfer position T2.

The method for manufacturing the transfer member 60 (an example of the elastic body having the two-layer structure), the transfer cylinder 50 (an example of the cylinder member), and the image forming apparatus 10 according to the exemplary embodiment have been described with reference to the accompanying drawings. It is noted that the method for manufacturing the transfer member 60, the transfer cylinder 50, and the image forming apparatus 10 according to the exemplary embodiment are not limited to those illustrated in the drawings. The method for manufacturing the transfer member 60, the transfer cylinder 50, and the image forming apparatus 10 may be changed or modified without departing from the scope of the gist of the present disclosure.

For example, the second elastic body 64 may joined to the first elastic body 62 by an adhesive agent, rather than the double-sided tape 58. The second elastic body 64 may be integrally joined to the first elastic body 62 by double injection molding. Furthermore, the transfer member 60 is not limited to the two-layer structure, but may have a three-layer structure or a structure having more than three layers.

Furthermore, although not illustrated, the transfer member 60 bent into a substantial “C” shape in cross section may be manufacturing using a provisional cylinder body having a substantially tubular shape. That is, the second elastic body 64 may be placed on an inner circumferential surface of the provisional cylinder body having the substantially tubular shape without the second elastic body 64 adhering to the inner circumferential surface of the provisional cylinder body, then the first elastic body 62 having an outer circumferential surface to which the double-sided tape 58 is bonded in advance is joined to an inner circumferential surface of the second elastic body 64, and thereafter the first and second elastic bodies 62 and 64 (that is, the transfer member 60) may be removed from the provisional cylinder body.

The transfer cylinder body 52 may be formed in a substantially columnar shape, rather than the substantially tubular shape. The cylinder member is not limited to the transfer cylinder 50, but may be, for example, a fixing cylinder that pressurizes a toner image so as to fix the toner image or a blanket cylinder for use in offset printing. The manufacturing method according to the exemplary embodiment is also applicable to such cylinder members.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for manufacturing an elastic body having a two-layer structure, the method comprising:
forming a first elastic body on a provisional cylinder body having a substantially circular shape in cross section; and
forming a second elastic body integrally with the first elastic body, which has been formed on the provisional cylinder body.

2. The method according to claim 1, wherein
the forming of the first elastic body comprises winding the first elastic body on the provisional cylinder body, and
the forming of the second elastic body comprises winding the second elastic body on the first elastic body, which has been wound on the provisional cylinder body, so as to join the second elastic body to the first elastic body.

3. The method according to claim 2, wherein the second elastic body is joined to the first elastic body by a double-sided tape.

4. A cylinder member comprising:
a cylinder body having a substantially circular shape in cross section; and
the elastic body having the two-layer structure that has been manufactured by the method according to claim 1, the elastic body being wound on the cylinder body.

5. A cylinder member comprising:
a cylinder body having a substantially circular shape in cross section; and
the elastic body having the two-layer structure that has been manufactured by the method according to claim 2, the elastic body being wound on the cylinder body.

6. A cylinder member comprising:
a cylinder body having a substantially circular shape in cross section; and
the elastic body having the two-layer structure that has been manufactured by the method according to claim 3, the elastic body being wound on the cylinder body.

7. An image forming apparatus comprising:
the cylinder member according to claim 4, the cylinder member being configured to transport a recording medium; and
an image forming unit configured to form an image on the recording medium transported by the cylinder member.

8. An image forming apparatus comprising:
the cylinder member according to claim 5, the cylinder member being configured to transport a recording medium; and
an image forming unit configured to form an image on the recording medium transported by the cylinder member.

9. An image forming apparatus comprising:
the cylinder member according to claim 6, the cylinder member being configured to transport a recording medium; and
an image forming unit configured to form an image on the recording medium transported by the cylinder member.
